(19) United States
(12) Patent Application Publication
(10) Pub. No.: US 2004/0220737 A1
(43) Pub. Date: Nov. 4, 2004

(54) Method for determining the relative elevation of points in a near-shore area and measuring device for establishing a stable instantaneous water level

(76) Inventors: Fendall Burian, Budapest (HU); Eduard Mogilevsky, Ashdod (IL); Yosef Quitt, Lion (IL)

Correspondence Address: FITCH EVEN TABIN AND FLANNERY, 120 SOUTH LA SALLE STREET, SUITE 1600, CHICAGO, IL, 60603-3406, US

(21) Appl. No.: 10/484,034

(22) PCT Filed: Jul. 2, 2002
(86) PCT No.: PCT/HU02/00063

(30) Foreign Application Priority Data
Jul. 16, 2001 (HU) P01 02969
Feb. 18, 2002 (HU) P02 00609

(51) Int. Cl. G06F 19/00

(52) U.S. Cl. 702/2

(57) ABSTRACT

The invention relates to a method in which the relative position of one or more geodetic points with respect to one or more other points of known height is determined so that a stable instantaneous water level is established in a confined area of the dead water; the relative height of the point of known height with respect to the instantaneous water level is determined; the relative heights of the geodetic points with respect to the instantaneous water level are determined; and the difference between the known height and the relative height of the point of known height is added or educted, respectively, to said relative heights of geodetic points. The stabile instantaneous water level may be established in preferably portable devices containing a measuring container (16) and a cover (18) provided with a hole (17) for equalizing air pressure; a telemeter (19) suspended on support means (21) for vertical adjustment, said support means being mounted on said cover (18); a wave and wind breaker jacket (15) arranged on supports (13) and a flexible water inlet pipe (27) connected to a stub (26) arranged at the bottom level of the measuring container (16) and passing through an opening (25) on the jacket (15), for communication between the container (16) and the dead water.

The invention relates to a method for determining the relative height of geodetic points arranged in a near-shore area, with respect to a point of known height above sea level. According to a further aspect, the invention comprises also a device for quick establishing the stable water level into it necessary to geodetic measurements.

The method according to the invention can be used preferably for the quick and cheap determination of the relative heights of two or more points on shores of dead waters (ocean, sea or lake).

The known and traditionally most preferred method for determining relative heights of different points or objects of earth surface with respect to the sea level is the spirit leveling (Spravochnik Geodezista, 2. edition, Moscow, Nedra Edition, 1975; G. Bomford, Geodesy 3^{rd} edition, Oxford Univ. Press, Oxford, 1971; R. E. Davis-F. S. Foote-J. M. Anderson-E. M. Mikhail: Surveying Theory and Practice, 6th edition, McGrow Hill, New York, 1981.)

However, by this method only the relative height of two points being in a distance of at most 100 m and in visual contact with each other can be determined with sufficient accuracy. In case of larger distances, a series of intermediate measurements should be performed corresponding to the former conditions. Heights are measured from the surface of the geoid forming the earth surface, or from the sea level representing it.

However, the actual value of sea level is not identical with the instantaneous level of a sea (ocean) measured at any point of it. A correct value may be obtained as the result of a rather long (at least 19 years) monitoring of the sea level. In addition, to measure the instantaneous water level is a difficult task too, due to the movement (waiving, tide etc.) of the water.

Thus, tide gauges are massive, fixed, stable structures installed in protected parts of the shore, e.g. in harbors, bays, in closed containers or buildings. The measuring device itself is mounted firmly on a rigid tube of large diameter, and this tube is concerted down to the bottom, or fixed to pillars or legs of bridges, ramps or barriers. In several cases the measuring device is arranged under the water level.

The common disadvantage of these solutions is the confinement to a single place, thus measurements can only be performed at the place of their installation. A further disadvantage is the costly nature of these solutions, including the necessity of a continuous guarding against illegal entry. Thus these devices cannot be used for measuring the heights of different points along any dead water, either.

A further disadvantage of geometrical leveling is that it is very cost- and time-consuming, a great number of measurements should be performed for achieving a result. The method is especially cumbersome in case of very diverse surface features of the ground. It is also a disadvantage that appropriate traffic connection should be ensured between the intermediate sites for transporting the measuring apparatuses. This is why the determination of height differences between points in a great distance is expensive and complicated, if it is possible at all.

Recently, a mathematical method called GPS (Global Positioning System) is also applied for determining height differences (B. Hoffmann-Wellenhof, H. Lichtenegger and J. Collins: GPS-Theory and Praxis, 2^{nd} edition, Springer Verlag, New York, 1992).

According to the GPS method, the height difference between two points is determined by mathematical calculation, on basis of the assumption that the points to be measured are arranged on an ellipsoidal body of rotation. By means of this method, the accurate data-base of whole countries can be established relatively easily. However, the accurate determination of the values of the levels of points can only be performed in relation to a surface of an ellipsoid, instead of geoid.

The object of the present invention is to eliminate the said disadvantages and to provide a method for adequate, quick and cost-effective determination of heights of geodetic points on the shore of dead waters based on the instantaneous water level, by portable and simple devices, even in cases when the points are in distances of tens (up to hundred) of kilometers from each other and without any visual connection.

Accordingly, the invention is a method in which the relative position of one or more geodetic points with respect to one or more other points of known height is determined so that

a stable instantaneous water level is established in a confined area of the dead water;

the relative height of the point of known height with respect to the instantaneous water level is determined;

the relative heights of the geodetic points with respect to the instantaneous water level are determined; and

the difference between the known height and the relative height of the point of known height is added or deducted, respectively, to said relative heights of geodetic points.

The stabile instantaneous water level may be established in preferably portable devices, arranged near to geodetic points being within distances of several tens of kilometers from each other, wherein the measurements may be carried out simultaneously in the devices provided with measuring apparatuses or one single device provided with measuring apparatuses is used and is transferred to each of the geodetic points to be measured.

The portable apparatus according to the invention contains a measuring container and a cover provided with a hole for equalizing air pressure; a telemeter suspended on support means for vertical adjustment, said support means being mounted on said cover; a wave and wind breaker jacket arranged on supports and a flexible water inlet pipe connected to a stub arranged at the bottom level of the measuring container and passing through an opening on the jacket, for communication between the container and the dead water, wherein said support means is preferably provided with a cross test level and the ratio of the inner cross sections of said water inlet tube and said measuring container is maximum 1/400.

The jacket is made of matching shell elements, which may be flat plates to be assembled to polygonal prisms or arcuate plates to be assembled to a cylinder or oval shaped shell or the like.

The shell elements may be provided with grooves fitting to each other when the shell elements are assembled to a shell and with bored ears at their ends and rods are threaded through the bores of the ears for connecting the shell elements.

The invention is based on the recognition that the instantaneous surface of a wave-free, dead water is always parallel to the geoidal surface, thus any point of it means a suitable point of relation for determining the height differences of relief points and/or built points.

At applying the present invention, the effect of external factors influencing the instantaneous sea level can be restricted to minimum owing to the following:

the effect of natural phenomena causing the movement of large water masses (tide, currents, etc.) is negligible if the two points selected are in a distance to each other of at most tens of kilometers, and measurements are performed simultaneously;

the effect of waves can be eliminated by the device used in which a wave-free water surface can be established for performing the measurements;

the effect of local characteristics in the point of measurements (density of water, temperature, air pressure) can be taken into account by determining them, and

in case of significant differences, results should be corrected by applying known calculation methods.

The invention is based on the recognition that a portable device can be developed by using small weight elements of identical structure for operating the measuring unit, which does not require the use of any other outfit, and in addition, protects the telemeter against external disturbances at any point of the sea shore.

Further details of the invention will be described by way of examples with reference to the enclosed drawings. In the drawings

FIG. 1 shows a schematic section perpendicular to the surface of a quiet near-shore area;

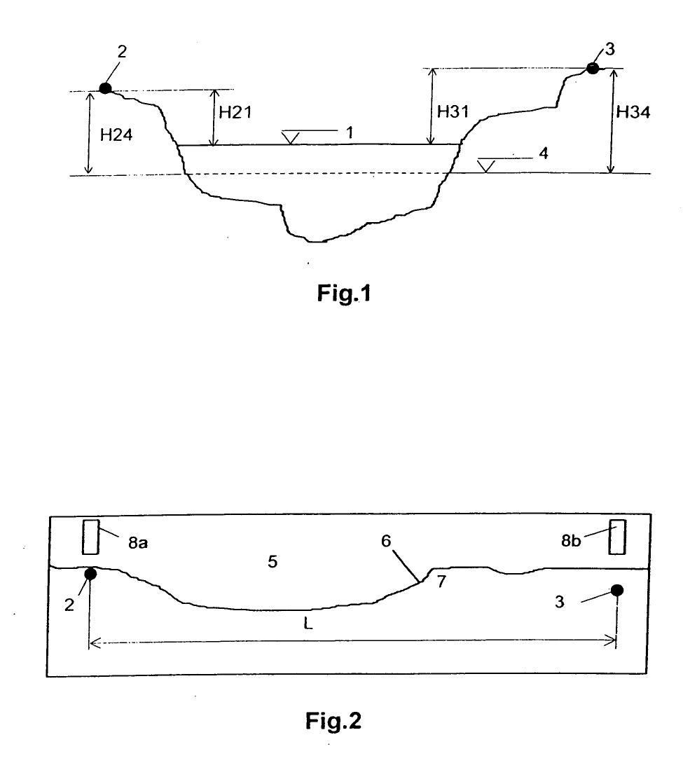

FIG. 2 is the schematic view of a near-shore area;

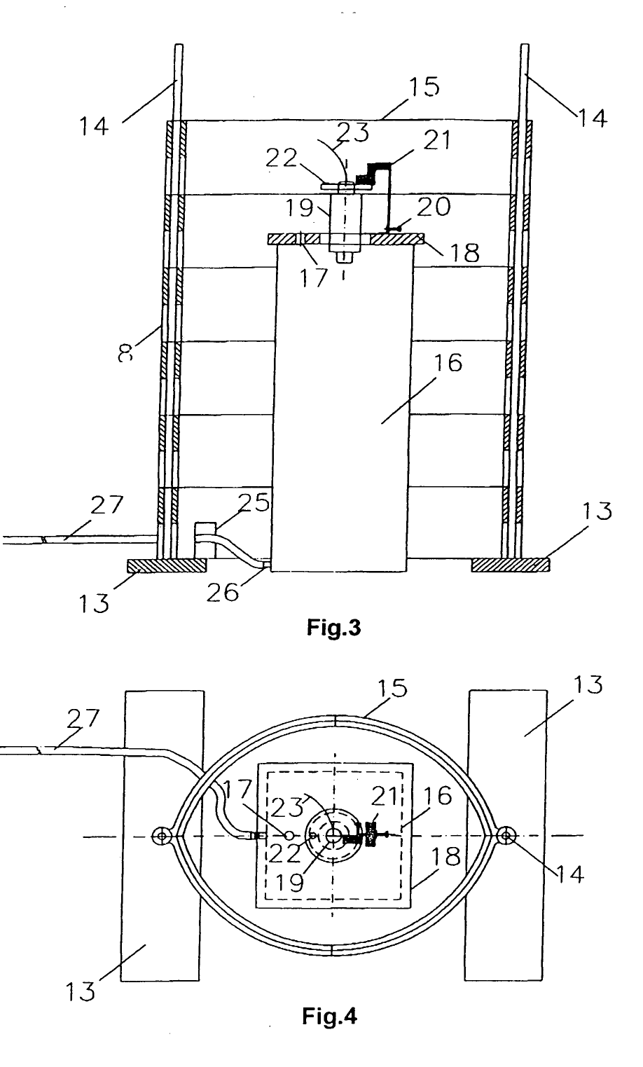

FIG. 3 is the longitudinal section of an embodiment of the device according to the invention;

FIG. 4 is the schematic top view of the device shown in FIG. 3;

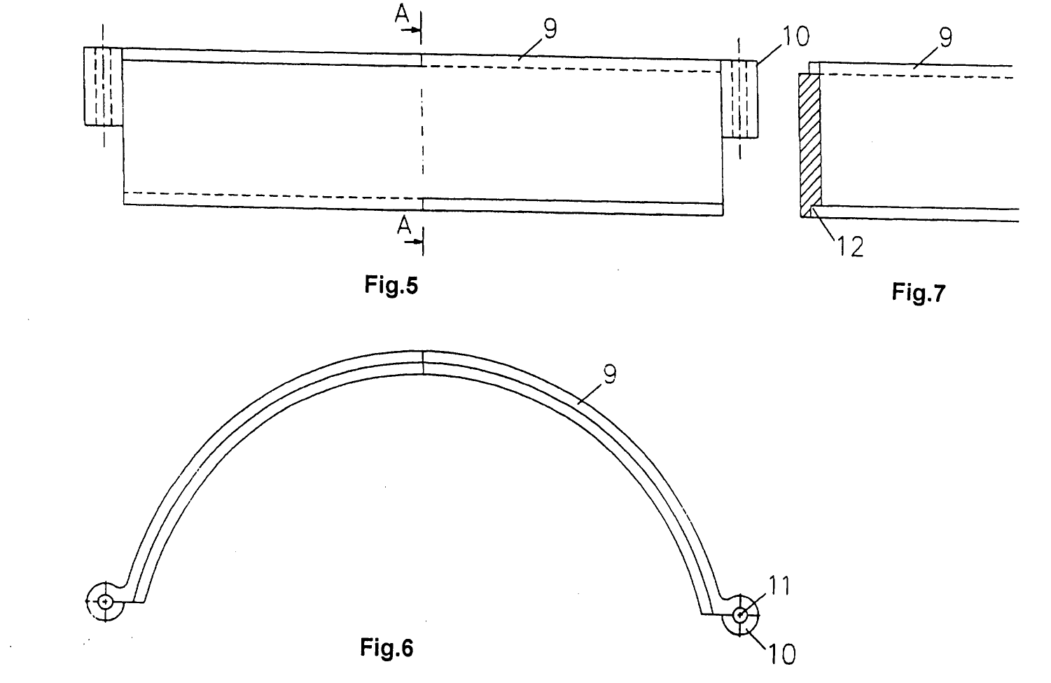

FIG. 5 is a schematic side-view of an embodiment of the grooved arch element according to the invention;

FIG. 6 shows the schematic top view of the grooved arch element shown in FIG. 5;

FIG. 7 is a schematic section of the grooved arch element along the A-A plane in FIG. 5;

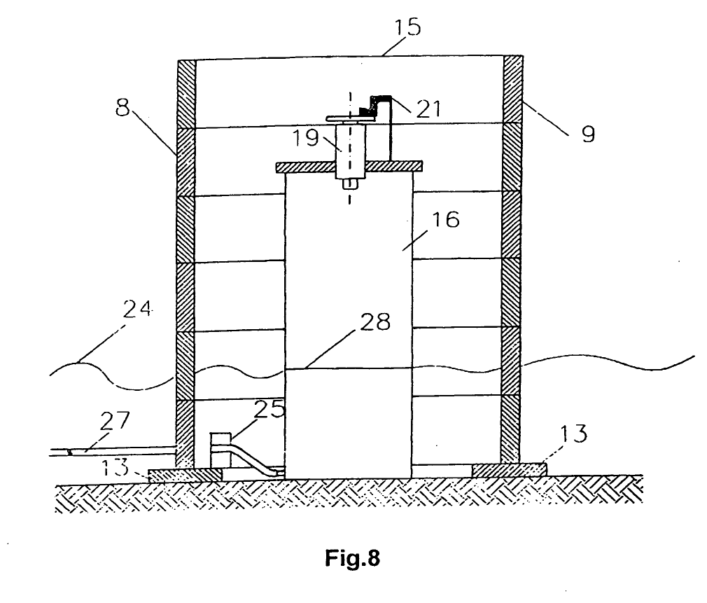

FIG. 8 illustrates the operational principle of the device according to the invention.

In FIGS. 1 and 2, the section and top view of a near-shore area is shown. According to the present invention, taking instantaneous water level 1 as the basis for points 2 and 3 at shore 7, the instantaneous height differences measured according to the invention is the same as the absolute height difference determined on the basis of main sea level 4 received by a 19 years monitoring:

H31−H21=H34−H24

Considering point 2 as known, the value of H24 is also known, and by measuring H21 and H31, the value of H34 can be calculated as

H34=H24−(H21−H31)

The height difference should be determined between known point 2 and unknown point 3 lying at shore 7 confined by shoreline 6 from dead water 5, being in a distance of L from each other, by the method according to the invention. The measurement was carried out by portable devices 8a and 8b arranged in dead water 5 and being in visual contact with points 2 and 3. Stable instantaneous water level was established at the measuring points, and the relative heights of points 2 and 3 were measured simultaneously with respect to the instantaneous water level.

Determination of heights for more points was performed by either using more devices, or by transferring one of the devices.

Table I contains comparative results of height determinations according to the traditional method and by the method of the present invention. Values marked by * and ** were measured at same places, but in different times for comparative purposes.

The data concern measurements carried out by the traditional method and by the method according to the invention.

TABLE I

| | | Probability | Period for | Ratio of |
|---|---|---|---|---|
| Distance | Difference | error limit | measurements | times for |
| between | between | of measure- | according to | the two |
| points | results | ments | invention | methods |
| (km) | (m) | (m) | (hour) | — |
| 14.5 | 0.01 | 0.0055 | 4.4 | 0.11 |
| 60 | 0.004 | 0.0071 | 4.2 | 0.03 |
| 9 | 0.014 | 0.0098 | 2.2 | 0.09 |
| 13 | 0.001 | 0.002 | 2.3 | 0.06 |
| 7 | 0.012 | 0.005 | 2.2 | 0.11 |
| 22 | 0.021 | 0.0034 | 2.6 | 0.04 |
| 8.5* | 0.014 | 0.0083 | 4.2 | 0.19 |
| 8.5* | 0.003 | 0.0032 | 4.2 | 0.19 |
| 8.5* | 0.007 | 0.0021 | 4.2 | 0.19 |
| 8.5* | 0.019 | 0.0111 | 4.2 | 0.19 |
| 110* | 0.042 | 0.0094 | 5.3 | 0.02 |
| 110* | 0.026 | 0.0051 | 5.3 | 0.02 |

It is seen from the table that the results of measurements carried out according to the method in the invention cover those obtained by the long and tiresome traditional method.

The measurements were carried out by the portable device provided with measuring apparatus making the quick and easy establishment of measuring sites possible.

The portable device shown in FIGS. 3-8 can be used for quick measurements at any point of the shores of dead waters.

A possible embodiment of device 8 is shown in FIGS. 3 and 4. The inner space of device 8 is protected by arched shell elements 9 illustrated in FIGS. 5-7. On sides of shell elements 9, ears 10 and in them, bores 11 are to be found. They are fitted to each other by grooves 12. The undermost shell element 9 is mounted on supports 13, and is assembled with the other shell elements 9 to the wave- and wind-breaker jacket 15 by means of rod 14 threaded through bores 11, as shown in FIGS. 3 and 4.

In the inner space of device 8, a measuring container 16 with a cover 18 provided with an air pressure equalizing boring 17 is situated, on which a telemeter 19 is mounted. The steady vertical position of the telemeter is ensured by a suspending structure 21 adjustable by screw 20.

Before performing the measurements, the vertical position of telemeter 19 should be checked by cross test level 22 on suspending structure 21 and it should be adjusted by screw 20. Data measured by telemeter 19 are transferred to a data recorder via cable 23.

Communication between the inner space of measuring container 16 and external water mass 24 is ensured by a flexible water inlet pipe 27 connected to an inlet stub 26 at the bottom level of measuring container 16. The inlet pipe 27 is passing through an opening 25 of the wind- and wave-breaker jacket 15, ensuring the transport of water there through.

The device according to the invention is working as shown in FIG. 8.

For assembling the device 8 transported to the required site in dismounted state, so many shell elements 9 should be used that the height of wave- and wind-breaker jacket 15 exceeds the height of the water increased by the wave height. Device 8 is placed to the water bottom on supports 13 and telemeter 19 is adjusted to a vertical position by suspending structure 21. In measuring container 16, a wave-free water surface is established, which forms a communicating vessel with external water mass 24 through water inlet pipe 27.

It is important that the surface of wave- and wind-breaker jacket 15 should be as small as possible (e.g. cylindrical with circular cross section), but at the same time, its mass should be large enough for the sake of stability and because it has to withstand the dynamic water pressure (vibrations). In order to increase the bearing area, it is standing on supports 13. However, also the requirement should be taken into account that the apparatus should be installed easily by one or two people. For the same reason, measuring container 16 should stand separately with respect to the wave-breaker jacket 15 in order to avoid effects from external forces.

Though, in principle, the device may operate without a longer water inlet pipe 27, it is suggested to take water from more distant places where the water is clear and stable. Measurement is usually carried out near to the coast, in shallow water, where the water is generally troubled (muddy) due to local waviness, and the “pulsating” water surface would also make difficulties.

For establishing the stable water surface, it is important that the ratio of inner cross sections of water inlet pipe 27 and that of measuring container 16 has to be at most 1/400. This ratio ensures that the change in water level in the container caused by pressure differences owing to waves, is negligible.

The main advantage of the device according to the invention is that it is portable, assembling and disassembling can be performed manually without any special tools at arbitrary points of the coast of a lake or sea. It is a specific advantage that the structure of the device is extremely simple, thus it is cheap, its operation costs are low, and it can be operated without any local and continuous guarding. A further advantage is that geodetic leveling of extended shore sections can be performed quickly by using two or more devices simultaneously.

The examples shown, of course, only illustrate the invention, and the solution can be utilized and realized in many ways within the scope of the claims. The shell elements may be planes from which arbitrary mantles in prismatic form can be developed. The connection of the elements may also be solved in different ways; e.g. by connecting extensions, without deviating from the sense and frame of the invention.

1. Method for determining the relative height of geodetic points bordering a dead water, with respect to a point of known height above sea level characterized in that
a stable instantaneous water level is established in a confined area of the dead water;
the relative height of the point of known height with respect to the instantaneous water level is determined;
the relative heights of the geodetic points with respect to the instantaneous water level are determined; and
the difference between the known height and the relative height of the point of known height is added or deducted, respectively, to said relative heights of geodetic points.

2. Method according to claim 1 characterized in that the stabile instantaneous water level is established in devices arranged near to geodetic points being within distances of several tens of kilometers from each other.

3. Method according to claim 2 characterized in that portable device are used.

4. Method according to claims 2 characterized in that measurements are carried out simultaneously in the devices provided with measurement apparatuses.

5. Method according to claim 1 characterized in that one single device is used and is transferred to each of the geodetic points to be measured.

6. Portable device for carrying out the method according to any of claims 1-5 characterized in that it contains
a measuring container (16) and a cover (18) provided with a hole (17) for equalizing air pressure;
a telemeter (19) suspended on support means (21) for vertical adjustment, said support means being mounted on said cover (18);
a wave and wind breaker jacket (15) arranged on supports (13 and
a flexible water inlet pipe (27) connected to a stub (26) arranged at the bottom level of the measuring container (16) and passing through an opening (25) on the jacket (15), for communication between the container (16) and the dead water.

7. Device according to claim 6 characterized in that said support means (21) is provided with a cross test level (22).

8. Device according to claim 6 characterized in that the jacket (15) is made of matching shell elements (9).

9. Device according to claim 8 characterized in that the shell elements (9) are flat plates to be assembled to polygonal prisms.

10. Device according to claim 8 characterized in that shell elements (9) are arcuate plates to be assembled to a cylinder or oval shaped shell or the like.

11. Device according to claim 8 characterized in that the shell elements (9) are provided with bored ears (10) at their ends and rods (14) are threaded through the bores (11) of the ears (10) for connecting the shell elements (9).

12. Device according to claim 6 characterized in that the shell elements (9) are provided with grooves (12) fitting to each other when the shell elements (9) are assembled to a shell.

13. Device according to claim 6 characterized in that the ratio of the inner cross section of said water inlet tube and said measuring container is maximum 1/400.
